(19) United States
(12) Patent Application Publication
(10) Pub. No.: US 2009/0177336 A1
(43) Pub. Date: Jul. 9, 2009

(54) System and Method for Triggering Vehicle Functions

(76) Inventors: Scott McClellan, Heber City, UT (US); Todd Follmer, Coto de Caza, CA (US)

Correspondence Address: STEPTOE & JOHNSON LLP, 1330 CONNECTICUT AVENUE, N.W., WASHINGTON, DC, 20036, US

(21) Appl. No.: 11/970,351

(22) Filed: Jan. 7, 2008

(51) Int. Cl. G06F 17/00

(52) U.S. Cl. 701/2; 701/36; 701/29

(57) ABSTRACT

System and method for remotely activating a vehicle function, comprising receiving an incoming message including an identification code; identifying one or more vehicles using the identification code; and sending a command to one or more of the vehicles. The incoming message may be associated with a telephone call, and the identification code may be caller identification information from the telephone call. The incoming message may be a packet-based message, and the identification code may be an identification of a sender of the message, such as an origination address. The identification code may be uniquely associated with one vehicle or multiple vehicles on a single user account. The command may be a command to lock or unlock one or more of the vehicles, or a command to start one or more of the vehicles.

### TECHNICAL FIELD

The present invention relates to a system and method for triggering or commanding the operation of vehicle systems.

### BACKGROUND

Generally, systems are available that allow a driver or user to command certain vehicle operations using a wireless device, such as opening car doors or starting a vehicle with a remote control or keyless door system on a keychain fob. Such systems may be used for a specific purpose only, such as locking/unlocking vehicle doors or starting the vehicle's engine. Typically, such systems uniquely link a particular device, such as a keyless remote, to a specific vehicle. Such devices typically cannot be used with more than one vehicle and often have limited functionality, such as only unlocking doors. Additionally, such devices usually require the user to be within a relatively close distance to the vehicle for the vehicle to respond to the device's commands.

Remote door unlock features are known in systems such as the OnStar system from General Motors. However, in the OnStar system, a user must call an OnStar operator or agent, provide an account number, and request that the operator or agent manually send a door unlock signal to the vehicle. The OnStar system does not provide users with the capability to interact with a vehicle without using an operator or agent. Moreover, the OnStar system does not provide the capability to remotely command other functions, such as door-lock commands or engine start commands.

### SUMMARY OF THE INVENTION

These and other problems are generally solved or circumvented, and technical advantages are generally achieved, by preferred embodiments of the present invention in which a user, such as a driver or owner of a vehicle, may control the operations of the vehicle remotely using, for example, a wireless device or telephone. The present invention allows the user to command vehicle functions, such as door locking or unlocking and engine start or shutdown, by sending an email or text message or by making a telephone call. The present invention does not require that the user have a traditional key, keyless entry system, or other remote control that is paired specifically to the vehicle. Instead, a control and monitoring system within the vehicle communicates with the user's telephone or wireless device directly or via a central server.

In accordance with one embodiment of the invention, a method for remotely activating a vehicle function, comprises receiving an incoming message including an identification code; identifying one or more vehicles using the identification code; and sending a command to one or more of the vehicles. The incoming message may be associated with a telephone call, and the identification code may be caller identification information from the telephone call. The incoming message may be a packet-based message, and the identification code may be an identification of a sender of the message, such as an origination address. The identification code may be uniquely associated with one vehicle or multiple vehicles on a single user account. The command may be a command to lock or unlock one or more of the vehicles, or a command to start one or more of the vehicles.

In accordance with another embodiment of the invention, a method for remotely triggering a vehicle operation, comprises receiving a message from a user; identifying one or more vehicles associated with the user; identifying a requested operation; and transmitting a command to one or more vehicles to perform the requested operation. The message may be a telephone call, and the one or more vehicles or the requested operation may be identified using a called number. The message may be a packet-based message, and the one or more vehicles or the requested operation may be identified using a destination address for the message.

In another embodiment, a system for controlling operation of vehicle functions, comprises a receiver for receiving vehicle operation commands, a processor coupled to the receiver, wherein the processor determines which vehicle system is associated with the vehicle operation command, and a vehicle system interface that allows the processor to trigger a function associated with the vehicle operation command. The system may further comprise a transmitter for sending vehicle status information to a remote server. The vehicle system interface may be an interface to an on-board diagnostic system for the vehicle or to an electrical system for the vehicle. The vehicle operation command may be associated with a door lock or unlock function, an engine start or shutdown function, or a command to disable a vehicle.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a vehicle monitoring and control system according to one embodiment of the invention;

FIG. 2 is a block diagram of a system incorporating an embodiment of the invention;

FIG. 3 illustrates a message used in embodiments of the invention;

FIG. 4 is a flowchart illustrating a method used in one embodiment of the invention; and

FIG. 5 is a flowchart illustrating a method used in another embodiment of the invention.

### DETAILED DESCRIPTION

The present invention provides many applicable inventive concepts that can be embodied in a wide variety of specific contexts. The specific embodiments discussed are merely illustrative of specific ways to make and use the invention, and do not limit the scope of the invention.

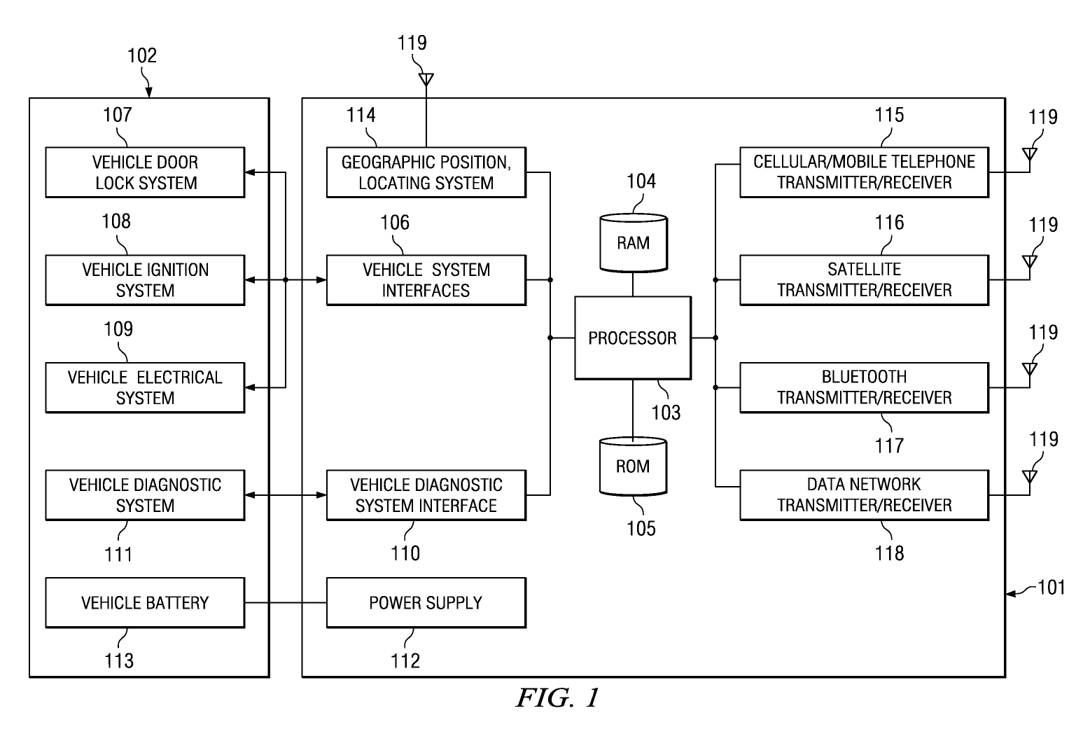

With reference now to FIG. 1, there is shown a vehicle monitoring and control system 101 that is coupled to one or more systems in vehicle 102. Processor 103 controls the operation of monitoring and control system 101. Processor 103 may be a general use processing device having software designed to control system 101. Alternatively, processor 103 may be a specially designed circuit or device, such as an application specific integrate circuit (ASIC), that is particularly designed for use in system 101. Processor 103 may use firmware or software, such as an operating system, for control and operation. Firmware, software and other data may be stored in random access memory (RAM) 104, read only memory (ROM) 105, electrically erasable programmable memory (EEPROM) devices, or other storage devices, such as magnetic media.

Monitoring and control system 101 includes one or more vehicle system interfaces 106 that allow system 101 to interact with systems in vehicle 102, such as door lock system 107, ignition system 108, and vehicle electrical system 109. Signals exchanged between interface 106 and door lock system 107 may allow monitoring and control system 101 to determine the lock/unlock status of vehicle doors and to command the door lock system to lock or unlock vehicle doors or windows, such as the passenger doors, trunk, hood, lift gate, side and rear windows, or sun roof. Signals exchanged between interface 106 and vehicle ignition system 108 may allow monitoring and control system 101 to determine the operating status of vehicle 102 and to command the ignition system to start or shutdown the engine of vehicle 102. Signals exchanged between interface 106 and vehicle electrical system 109 may allow monitoring and control system 101 to determine the status of other vehicle systems and to command other systems to operate. For example, vehicle electrical system 109 may provide control of the vehicle's horn, interior and/or exterior lights, entertainment system, navigation system, heating and/or air conditioning systems, or alarm system.

Vehicle diagnostic system interface 110 provides a connection between monitoring and control system 101 and vehicle diagnostic system 111. Vehicle diagnostic system 111 may be an on-board diagnostic (OBD) II system or a controller area network (CAN) system in vehicle 102 that is accessed via a port or data bus. The OBD/CAN system provides access to engine performance and status data, speedometer, odometer and tachometer data, and data from other vehicle systems. Power supply 112 provides power to monitoring and control system 101. Power supply 112 may be a self-contained battery, for example, or it may be coupled to another power source, such as vehicle battery 113. There may be a direction connection between power supply 112 and vehicle battery 113 or power supply may get vehicle power via the OBD/CAN bus in vehicle 102, for example.

Monitoring and control system 101 further includes geographic position locating system 114, which provides location information for vehicle 102, such as a latitude/longitude. In one embodiment, geographic position locating system 114 is a global positioning system (GPS) that uses satellite signals to determine location. Other navigation or location-determining systems may also be used, such as inertial navigation systems that update a vehicle's location as it moves from a known position or terrestrial-based radio navigation systems, such as LORAN.

Monitoring and control system 101 includes one or more systems that provide communications with other devices and systems. For example, monitoring and control system 101 may include cellular or mobile telephone transmitter/receiver 115 that allows system 101 to communicate with other devices and to send or receive data via a cellular or mobile network. Satellite transmitter/receiver 116 allows system 101 to communicate with other devices and to send or receive data via satellite network communications. Bluetooth transmitter/receiver 117 allows system 101 to communicate with other devices that have Bluetooth capability. Data network transmitter/receiver 118 allows system 101 to communicate via networks, such as data communication networks using WiFi, 802.11, WiMAX, or other standards or protocols, for example. Monitoring and control system 101 may further include one or more antennas 119 to support communications. Antennas 119 may be internal to monitoring and control system 101, may be formed as an integral part of a housing for system 101, or may be externally mounted on a vehicle.

One embodiment of a vehicle monitoring and control system is described in U.S. patent application Ser. No. 11/805,237, entitled “System and Method for Monitoring Vehicle Parameters and Driver Behavior,” filed May 22, 2007, the disclosure of which is incorporated by reference herein in its entirety.

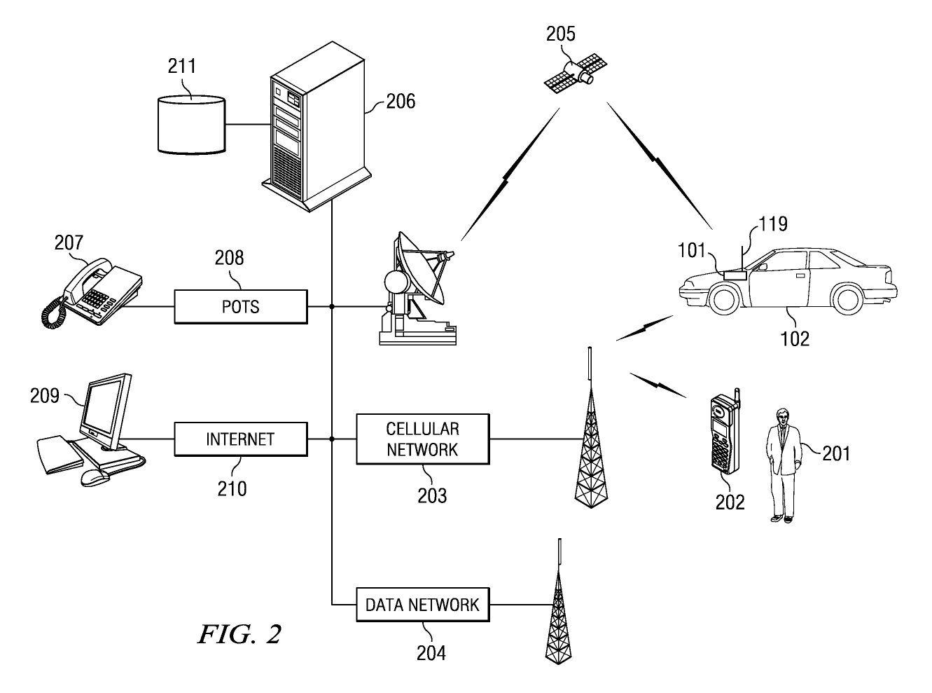

FIG. 2 illustrates a system in which user 201 is able to command certain functions and operations of vehicle 102 using wireless device 202, for example. Monitoring and control system 101 may be installed or mounted in any location in vehicle 102, such as in a trunk, under a seat, in a glovebox, or on a window or dashboard. One or more antennas 119 are also installed on vehicle 102 and/or mounted with monitoring and control system 101 to support communication with one or more networks. Monitoring and control system 101 may be capable of communicating with one or more networks, such as cellular or mobile telephone network 203, wireless data network 204, such as a Bluetooth, WiFi, WiMAX or 802.11 network, or satellite 205.

Wireless device 202 may be a cellular, mobile or satellite telephone, personal digital assistant (PDA), two-way pager, mobile messaging device, such as a Blackberry® or Treo®, or similar device. Wireless device 202 may also be capable of communicating with one or more networks, such as cellular or mobile telephone network 203, wireless data network 204, or satellite network 205.

Server 206 may also be coupled to multiple networks, such as cellular network 203, wireless data network 204, or satellite 205. In one embodiment, server 206 is configured to forward commands from user 201 and wireless device 202 to monitoring and control system 101 in vehicle 102. User 201 may communicate with server 206 via wireless device 202. Alternatively, user 201 may communicate with server 206 via a wireline connection, such as telephone 207, which may be coupled to plain old telephone system (POTS) 208. In another embodiment, user 201 may use a personal or laptop computer 209 to communicate with server 206, such as via Internet 210 or any other public or private data network.

In an exemplary embodiment of the present invention, user 201 desires to unlock the doors of vehicle 102. Instead of using typical methods of unlocking the vehicle doors, such as a key or a remote keyless entry system, user 201 may command the doors to unlock using wireless device 202. User 201 may dial a telephone number associated with server 206. A call may be established between wireless device 202 and server 206 via cellular network 203. Alternatively, user 201 may use telephone 207 and establish a call to server 206 over POTS 208. Server 206 may provide an interactive voice response (IVR) or menu-driven interface to user 201. Server 206 may play a message prompting the user to enter information that identifies the user and/or the vehicle, such as an account number, license plate number, drivers license number, vehicle identification number (VIN), or the like. The user may enter information by speaking and/or by pressing the number keys on device 202 or telephone 207.

Once the user has been identified, server 206 may look up the user's account in memory 211, which may include, for example, a database that associates users and vehicles. If the user is associated with more than one vehicle, the user may be prompted to select one or all of the vehicles. The user may also be prompted to provide a password or personal identification number (PIN), or some other security feature may be used to confirm the caller's identity or authorization to use the system.

Once the user's authorization has been confirmed and the vehicle has been identified, the user may be prompted to select a vehicle feature or operation to be activated or performed. For example, server 206 may provide user 201 with a menu or list of features from which user 201 then selects a desire function, such as a door-unlock command. Server 206 then sends the door-unlock command to vehicle 102 via an appropriate communication network. A database or a user account file in memory 211 may include information associated with vehicles that have a monitoring and control system 101 installed. Various embodiments of the monitoring and control systems 101 may use different methods of communication, such as a cellular network 203, data network 204, or satellite 205. Upon receiving user 201's door-unlock instructions, server 206 determines the available and/or preferred method of communication with user 201's vehicle and sends a door-unlock command to monitoring and control system 101 using the preferred method or network.

When monitoring and control system 101 receives the door-unlock command, it unlocks the vehicle's doors, such as by directly signaling the vehicle door lock system 107 through a vehicle system interface 106 (FIG. 1). In one embodiment, monitoring and control system 101 is capable of confirming that the doors have been unlocked. Monitoring and control system 101 may send an acknowledgement to server 206 to confirm that the door-unlock signal has been received, that the door lock system has been commanded to unlock, and/or that the doors have actually been unlocked. Upon receipt of the acknowledgement signal, server 206 may forward the acknowledgement to user 201 via device 202 or 207, such as by playing a pre-recorded message.

In one embodiment, server 206 may require that the acknowledgement message is received from monitoring and control system 101 within a preset time period. If the acknowledgement message is not received, then the door-unlock command may be resent to system 101. If the door-unlock command is resent to vehicle 102, server 206 may send the second and/or subsequent messages via the same network (203-205) as the first message, or a different network may be selected. For example, if a door-unlock command is sent via cellular network 203 to vehicle 102, but no acknowledgement is received, then server 206 may resend a door-unlock command again via cellular network 203. Alternatively, server 206 may resend the door-unlock command via satellite 205 or data network 204, if monitoring and control system 101 is configured to communicate via those networks. If no acknowledgement message is received, then user 201 may be notified that the requested operation failed or may have failed.

In another embodiment, user 201 may use a text message, email, SMS message, or other data connection to command the doors on vehicle 102 to unlock. For example, wireless device 202 may be capable of sending text messages or email messages. User 201 may send a text or email message to an address or port associated with server 106. The message may include a user, account or vehicle identifier and a desired command, function or operation. Alternatively, a series of text or email messages may be exchanged between user 201 and server 206 in order to first identify the user and to confirm the user's authorization, and then to provide the desired command to the user's vehicle. Once server 206 has confirmed that the command is authorized, it will send the command to monitoring and control system 101 via the appropriate network as described above. Monitoring and control system 101 may also send an acknowledgement message in reply as further discussed above.

It will be understood that the selected communication method or network between sever 206 and monitoring and control system 101 may be independent of the communication format used between user 201 and server 206. For example, user 201 may communicate with server 106 via a voice, data, text, or email format over networks 203-205; and server 206 may in turn communicate with monitoring and control system 101 via the same or a different type of network.

User 201 may also use personal or laptop computer 209 to send email or text messages to server 201 to control features or operations of vehicle 101. In another embodiment, instead of communicating with server 206 via email or text messages, user 201 may use personal or laptop computer 209 to access a webpage or other user interface associated with server 206. User 201 may then log-in to server 206, identify an account and/or vehicle, and select a desired operation to be performed by vehicle 102. Server 206 then transmits a command to monitoring and control system 101 to trigger the selected operation. The webpage or user interface may also provide feedback to indicate to the user whether the operation was successfully performed.

The webpage or user interface may require user 201 to enter an account identifier and password to confirm that the user is authorized to access vehicle information and/or commands. The webpage and/or user interface may also provide access to enter, updated or edit account information, such as user data, vehicle data, and monitoring and control system data.

It will be understood that any number of functions, operation or actions may be commanded remotely using the present invention. For example, in addition to, or instead of, commanding the vehicle doors to unlock, the present invention may be used in other embodiments to lock the vehicle doors, start or shutdown the engine, control the exterior and interior lights, blow the horn, open or close windows, disable or enable the engine, ignition and/or transmission, and control the navigation, audio and video systems.

The user account data, which may be stored, for example, in memory 211, may include a list of telephone numbers, such as home, work or cell phone numbers, a list of email, text or other message addresses, and a list of vehicles associated with the user. Server 206 may identify the user and/or vehicle by having the user enter an identifier or account number. Alternatively, server 206 may associate a telephone number or message address to a specific user or vehicle. For example, a particular telephone number may be associated with a user or vehicle in a user account file, such as a telephone number for wireless device 202 or telephone 207. When server 206 receives a call, it may use caller identification information to identify the calling device, such as wireless device 202 or telephone 207. After identifying the calling number and/or calling device, server 206 may search a database of user account information, such as a database in memory 211, to identify an account associated with the calling number or device. Upon identifying the appropriate user account, server 206 may then retrieve a list of one or more vehicles 102 that are associated with the account. If more than one vehicle is associated with the account, then user 201 may be prompted to select one or more of the vehicles to receive the selected command. Alternatively, if user 201 sends an email, text or other message to server 206, the user's account may be identified by comparing the sender's internet protocol (IP) or other originating electronic address in the message to account data.

In other embodiments, server 206 may have a plurality of incoming telephone lines and a specific incoming line may be assigned to particular user or vehicle. By identifying the called number, server 206 may identify the user that is requesting an action or the vehicle that is to receive a command by determining which vehicle or user is assigned to that called number. Similarly, a number of IP or electronic messaging addresses may be associated with server 206 and each may be assigned to a particular user or vehicle. Sever 206 may determine which user is requesting an action, or which vehicle is to receive a command, by identifying the destination address of incoming messages.

Alternatively, the called telephone, incoming telephone line and/or destination address may be associated with a desired function, instead of a particular user or vehicle. For example, a particular telephone number may be assigned to a door unlock function. Server 206 may be programmed to associate all incoming calls to that telephone number or all incoming messages to that IP address with the door unlock function. Server 206 then identifies which vehicle should receive a door-unlock command by prompting user input or by using caller identification or sending message address to identify the vehicle or user. Once server 206 determines which vehicle or vehicles should receive the command, it sends the command using the appropriate network 203-205. Similarly, a messaging address may be associated with the door unlock function. When server 206 receives an incoming message directed to the unlock function messaging address, server 206 needs only to identify the user or vehicle before sending out the door-unlock command. The user or vehicle may be determined by user input, as discussed above, or by looking at the message content or message origination address. The message content may identify a vehicle, such as by listing a VIN, license plate, or account number.

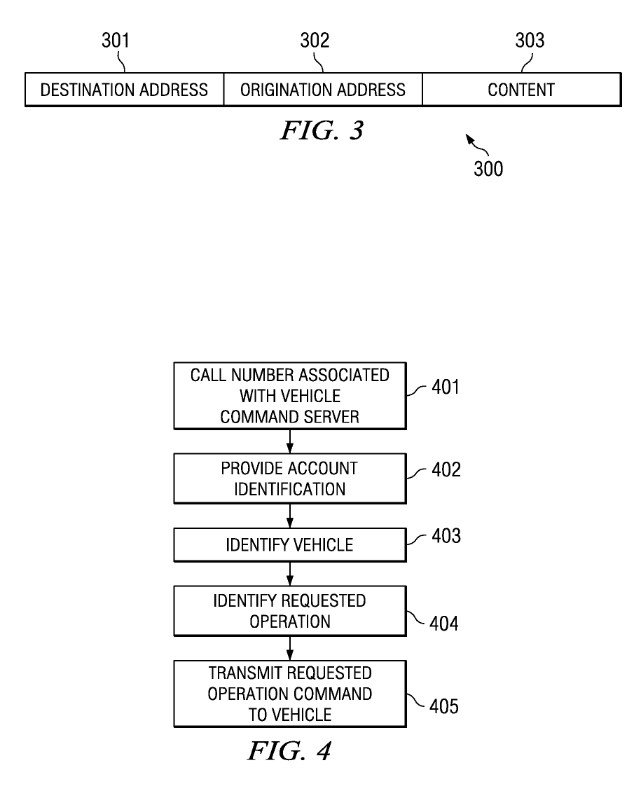

FIG. 3 is a simplified illustration of message 300, which may be used with the present invention. Wireless device 202 or computer 209 may be used to send message 300 to server 206. Destination address 301 may be assigned to, or routed to, server 206, which may associate the destination address with a particular user, vehicle or desired function. Server 206 may also or alternatively use origination address 302 to identify a user, vehicle or requested function. Alternatively, message content 303 may include data that identifies the user, vehicle and/or desired function. Server 206 process the content information, such as by parsing out predetermined fields, and determines the command to be sent and the vehicle to receive the command. Server 206 then creates the command, such as a door-unlock command, and transmits it to the vehicle.

In another embodiment, wireless device 202 and control and monitoring system 101 may be Bluetooth capable. If the wireless device has been configured to work with the Bluetooth system in vehicle 102 or system 101, user 201 may send door-unlock or other commands via Bluetooth messages. Wireless device 202 may run a software application that provides a list of vehicles and/or commands for user 201 to select. This embodiment would avoid the need to use more expensive satellite or cellular airtime, and would also avoid the need to use server 206 to relay messages.

FIG. 4 is a flowchart illustrating a method of using one embodiment of the invention. In step 401, the user calls a telephone number associated with a vehicle command server, such as server 206 (FIG. 2). In step 402, the user provides account identification information. The user may enter account information in response to prompts from a voice menu or IVR system. The user may enter account information by speaking and/or using a keypad on a telephone or wireless device. The account information may be a user identifier or account number. In step 403, the user or the server identifies the vehicle that should receive a command. The user may identify the vehicle by selecting it from a menu or by entering a vehicle identifier, such as a license plate or VIN. The server may also identify the vehicle from the account information. In step 404, the user identifies a requested operation to be performed by the vehicle. The user may select an operation from a list or menu, or the user may provide a code corresponding to the requested operation, such as by entering “1” to unlock doors, “2” to lock doors, “3” to start the vehicle, etc. In step 405, the server transmits a command for the requested operation to the vehicle. The command is transmitted using an appropriate network for the vehicle, such as via a cellular network or satellite network.

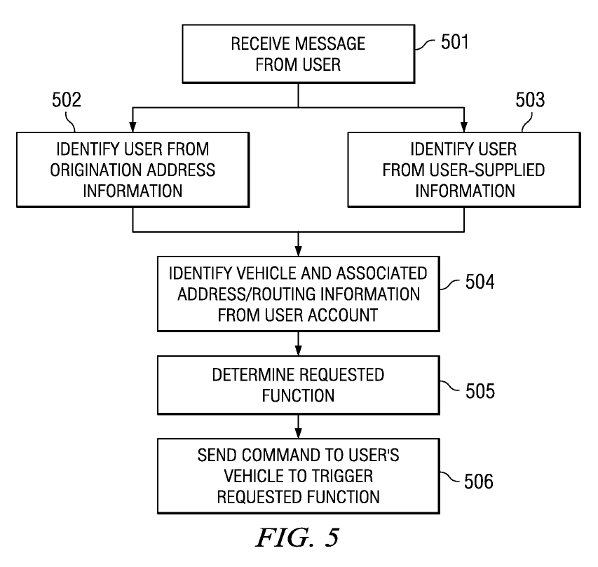

FIG. 5 is a flowchart illustrating a method of using another embodiment of the invention. In step 501, a vehicle command server receives a message from a user. The message may be received via an email, SMS message, text message, or the like. In step 502, the server identifies the user from origination address information in the message. Alternatively, in step 503, the server identifies the user from user-supplied information, such as from an account number or use name in the message content or payload. In step 504, the server uses the user's account information to identify a vehicle and the associated address/routing information. In step 505, the server determines the requested function. The server may identify a default function that is associated with the destination message address, such as messages addressed to unlockdoors@server.com, for example, may be requests for a door-unlock command. Alternatively, the user may specify a desired function in the message content or payload. In step 506, the server sends a command to the user's vehicle to trigger requested function

In one embodiment, a remote vehicle operation triggering system recognizes a user via caller identification information (e.g. caller id)_or using an identification number input by the user. An identification number may be assigned to the user during registration or at some other time. In an embodiment, at the time of registration of the unit, the user is asked for telephone numbers that may be used to unlock the vehicle remotely, or used to trigger other vehicle functions and operations. The user then enters various telephone numbers, such as home, work, and mobile device telephone numbers. The numbers are added to an approved list associated with the user's vehicles. When the user calls the system, such as by dialing a 1-800 number from a telephone having a number previously identified by the user, the system will unlock the vehicles registered to that phone number. If the user has not assigned any telephone number to his account, or if he is not able to call from one of the designated numbers, then the user may call the system number and then respond to a menu function, for example, to enter the assigned telephone number or other Personal Identification Number (PIN) for the system. When the user enters the telephone number and/or PIN, he may be prompted to further enter a pass code to unlock the vehicle or to perform another preprogrammed function or operation. In one embodiment, the default action is to unlock the vehicle. However, any other vehicle operation, such as moving windows up/down, moving a convertible roof up/down, turning an ignition on/off, turning a heater or air conditioner on/off, turning vehicle lights on/off, or honking a horn may also be performed remotely.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for remotely triggering a vehicle function, comprising:
receiving an incoming message including an identification code;
identifying one or more vehicles using the identification code; and
sending a command to one or more of the vehicles.

2. The method of claim 1, wherein the incoming message is associated with a telephone call; and
wherein the identification code is caller identification information.

3. The method of claim 1, wherein the incoming message is a packet-based message; and
wherein the identification code is an identification of a sender of the message.

4. The method of claim 1, wherein the identification code is uniquely associated with one or more vehicles.

5. The method of claim 1, wherein the identification code is associated with a user account; and
wherein the one or more vehicles are associated with the user account.

6. The method of claim 1, wherein the command is a command to lock or unlock one or more of the vehicles.

7. The method of claim 1, wherein the command is a command to start one or more of the vehicles.

8. A method for remotely triggering a vehicle operation, comprising:
receiving a message from a user;
identifying one or more vehicles associated with the user;
identifying a requested operation; and
transmitting a command to one or more vehicles to perform the requested operation.

9. The method of claim 8, wherein the message is a telephone call; and
wherein the one or more vehicles are identified using a called number.

10. The method of claim 8, wherein the message is a packet-based message; and
wherein the one or more vehicles are identified using a destination address for the message.

11. The method of claim 8, wherein the message is a telephone call; and
wherein the requested operation is identified using a called number.

12. The method of claim 8, wherein the requested operation is identified using a Personal Identification Number (PIN).

13. The method of claim 8, wherein the message is a packet-based message; and
wherein the requested operation is identified using a destination address for the message.

14. A system for controlling operation of vehicle functions, comprising:
a receiver for receiving vehicle operation commands;
a processor coupled to the receiver, wherein the processor determines which vehicle system is associated with the vehicle operation command; and
a vehicle system interface that allows the processor to trigger a function associated with the vehicle operation command.

15. The system of claim 14, further comprising:
a transmitter for sending vehicle status information to a remote server.

16. The system of claim 14, wherein the vehicle system interface is an interface to an on-board diagnostic system for the vehicle.

17. The system of claim 14, wherein the vehicle system interface is an interface to an electrical system for the vehicle.

18. The system of claim 14, wherein the vehicle operation command is associated with a door lock or unlock function.

19. The system of claim 14, wherein the vehicle operation command is associated with an engine start or shutdown function.

20. The system of claim 14, wherein the vehicle operation command is associated with a command to disable a vehicle.

21. A method for remotely activating a vehicle function, comprising:
receiving, at a location remote from the vehicle, an incoming message including caller identification information;
identifying one or more vehicles using the caller identification information; and
sending a command to one or more of the vehicles, wherein the command activates the vehicle function.

22. The method of claim 21, wherein the vehicle function is selected from the group consisting of:
opening or closing vehicle windows;
opening or closing a convertible vehicle roof;
turning on or off a vehicle ignition;
turning on or off a vehicle heater;
turning on or off a vehicle air conditioning system;
turning or off vehicle lights; and
honking a vehicle horn.

23. A method for remotely deactivating a vehicle function, comprising:
receiving, at a location remote from the vehicle, an incoming message including caller identification information;
identifying one or more vehicles using the caller identification information; and
sending a command to one or more of the vehicles, wherein the command deactivates the vehicle function.

24. The method of claim 23, wherein the vehicle function is selected from the group consisting of:
opening or closing vehicle windows;
opening or closing a convertible vehicle roof;
turning on or off a vehicle ignition;
turning on or off a vehicle heater;
turning on or off a vehicle air conditioning system;
turning or off vehicle lights; and
honking a vehicle horn.
